(19) United States
(12) Patent Application Publication
(10) Pub. No.: US 2005/0227080 A1
(43) Pub. Date: Oct. 13, 2005

(54) Method for coating fiber-reinforced plastic structural parts and structural part so produced

(76) Inventors: Karlheinz Horsting, Karlsruhe (DE); Rudolf Kuhfusz, Gondelsheim (DE)

Correspondence Address: FULBRIGHT & JAWORSKI, LLP, 666 FIFTH AVE, NEW YORK, NY, 10103-3198, US

(21) Appl. No.: 10/507,402

(22) PCT Filed: Mar. 20, 2003
(86) PCT No.: PCT/EP03/02911

§ 371 Date: Apr. 8, 2005

(30) Foreign Application Priority Data
Mar. 21, 2002 (DE) 102 12 415.9
Mar. 5, 2003 (DE) 103 09 811.9

(51) Int. Cl. B29C 43/00; B32B 27/00

(52) U.S. Cl. 428/411.1; 264/257; 264/510; 264/324; 428/500

(57) ABSTRACT

Fiber-reinforced structural parts are coated to refine and color the surfaces especially if they are used as body parts in the automotive industry. According to the invention, a plastic film that already has the desired properties regarding the structure and optionally the color of the surface of the structural part and that is already preformed corresponding to the topography of the surface of the structural part is inserted in a corresponding mold. A fiber-reinforced plastic, preferably comprising a duroplastic or thermoplastic matrix, is applied to the side of the preformed film that is not the surface by means of a method adapted to the composition of the semi-finished product and finished structural part is withdrawn from the mold once the fiber-reinforced plastic has been pressed and hardened or cooled off.

The invention relates to a method for refining surfaces of structural parts made of reinforced-reinforced plastics materials according to the preamble of the first claim, and to a structural part so produced.

Structural parts made of reinforced-reinforced plastics materials, wherein the structural part is produced using the resin-transfer-molding (RTM) process, the long-reinforced-reinforced thermoplastic (LFT) process, the glass-mat-reinforced thermoplastic (GMT) process or the sheet-compound-compound (SMC) process, for example, are coated in order to refine and color the surfaces, in particular if they are used as body parts in the manufacturing of motor vehicles. The coating process is, however, very laborious, as the surfaces of the plastics material structural parts must be prepared for the coating process, on account of the production processes, which cause an uneven surface structure. Surface defects on non-refined structural parts may be caused, for example, by voids, craters or protruding fiber ends. A mechanical surface treatment, by means of grinding or smoothing, for example, is generally required, so that the necessary surface quality may only be obtained with a high degree of manual effort. The additional application of surface coatings, for example resinous non-woven coatings or IMC (in-mould coating), also aims to level the surface.

It is known from the specialist paper by Achim Grefenstein, Folienhinterspritzen statt Lackieren, in Metalloberfläche—Beschichten von Kunststoff und Metall, Vol. 10/99, Carl Hanser Verlag, Munich, to use films for refining surfaces in injection-molding technology. The films are inserted, preformed, into an injection mould. The cavity of the film is then insert-molded, in a known manner, with plastics material, in order to produce the refined surface in a single operating step. However, only relatively small plastics material structural parts, up to specific dimensions, may be produced using the film insert molding technique. Larger structural parts, such as the front or tail gates of passenger vehicles or the wind deflectors of industrial vehicles, for example, which, as a result of their fiber reinforcement, also display the required mechanical properties, may be produced using the pressing processes or the RTM process, for example. However, the surface quality required for coating cannot be achieved using these processes either.

The object of the invention is to reduce the effort involved in refining the surfaces of structural parts made of reinforced-reinforced plastics materials.

The object is achieved in that a plastics material film that already displays the desired properties with regard to the structure and optionally the color of the surface of the structural part and that is preformed in accordance with the topography of the surface of the structural part is inserted into a mould corresponding to the dimensions of the structural part, in that, in a process that is adapted to the composition of the semi-finished product, a reinforced-reinforced plastics material, preferably comprising a thermoset or thermoplastic matrix, is applied to the side of the preformed film that is not the surface, and in that, after the reinforced-reinforced plastics material has hardened or cooled, the finished structural part is removed from the mould.

The surface of the structural part may be refined by means of film insert molding or film resin-transfer-molding (film RTM). In the case of film insert molding, the preformed film is placed on one of the molding tools of a press, into the female mould or onto the male mould, the reinforced-reinforced plastics material, in the form of a mat or a polymer melt, is placed on the counterpart of the tool of the press, and, in a pressing process that is adapted to the composition of this semi-finished product, the preformed film is connected to the mat or the polymer melt.

Film resin-transfer-molding takes place in a closed mould, which is comparable to the closed compression moulds, the female moulds and male moulds, of a press. The preformed film is inserted into the mould and a fiber mat, i.e. only the fiber reinforcement, is inserted under the cavity of said mould. In a known manner, the mould, once evacuated, is filled with a mixture of resin and hardener, the mat being saturated and the cavity under the film being filled. The mould remains closed until the injected resin has hardened. This technique is also conceivable in the open process.

The method according to the invention allows large structural parts with large surfaces, such as boot lids or door elements, for example, to be produced cost-effectively both by film insert pressing and by film resin-transfer-molding, and with a surface quality that is comparable to that obtained with known film insert molding. Reinforced-reinforced plastics materials and treatment processes may now be applied with which, in the past, the surfaces produced could only be refined with the above-described high degree of effort. The films may contain colored layers or specially prepared coating layers. Coextruded, two-coat or three-coat films, as are also used in film insert molding, are particularly suitable. The coextrusion of thin, colored plastics material layers within a two-coat or three-coat composition allows layers to be built up that are similar to coating layers. The method according to the invention allows reinforced-reinforced plastics materials, preferably comprising a thermoset or thermoplastic matrix, to be refined without preparing the surface and without coating, in a substantially smaller number of operating steps than in the conventional method. A subsequent coating procedure, with reduced effort, is possible for effect colors.

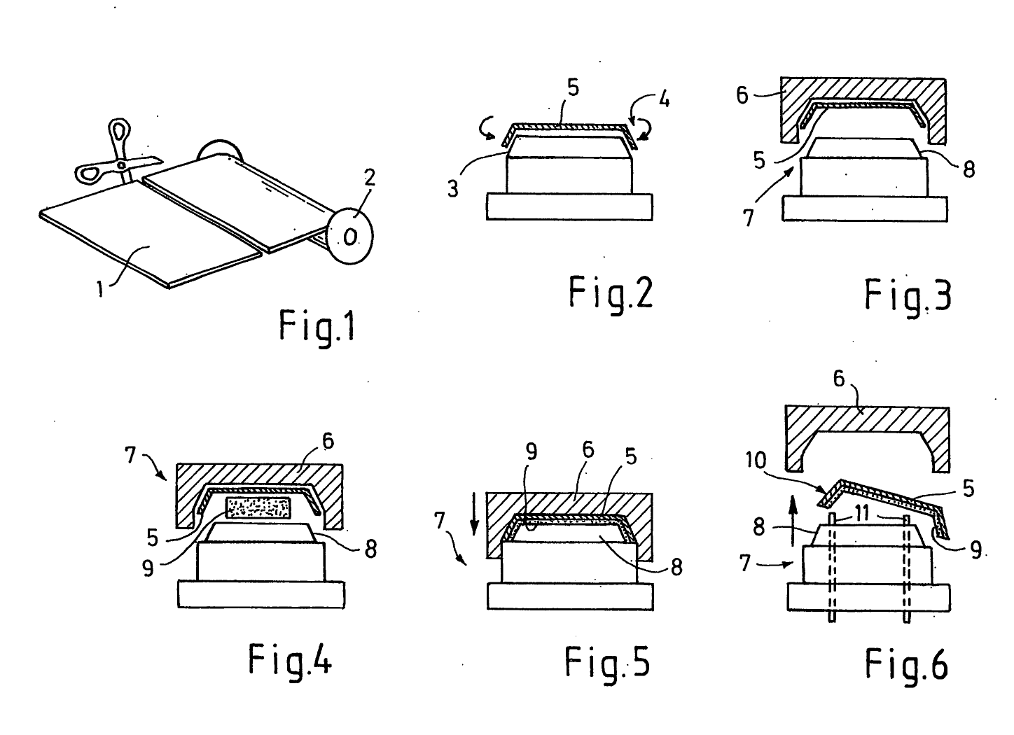

The course of the film insert pressing process is illustrated in greater detail in a flow diagram, with reference to the process steps shown schematically in FIGS. 1 to 6.

In the process step according to FIG. 1, a film 1 that is suitable for the film insert pressing process is removed from a roller 2 and cut to the required size. In the process step according to FIG. 2, this film 1 is placed on a mould 3 that displays the topography of the surface of the structural part to be produced, and, during the film preforming, is deformed by means of suitable devices, indicated by the reference numeral 4, preferably under thermal influence, in such a way that a film 5 having the topography of the surface of the structural part to be produced is created. After any protruding flashes and material remnants have been removed (in a manner not shown here), the preformed film 5, in the process step according to FIG. 3, is placed into the female mould 6 of a schematically illustrated press 7. The contour of the male mould 8 allows for the wall thickness of the structural part to be produced. In the process step according to FIG. 4, a semi-finished product 9 made of reinforced-reinforced plastics material is inserted into the press 7, below the cavity of the film 5, so that the preformed film 5 is the outer surface or display side, i.e. the side of the structural part that is visible and exposed to the environment. In the process step according to FIG. 5, a molding process that is adapted to the semi-finished product 9 takes place, wherein the reinforced-reinforced plastics material fills the cavity between the male mould and the preformed film 5, and adapts to the contour thereof. Reinforced-reinforced plastics materials that may be deformed by means of extrusion and thermal processes, in particular SMC, GMT and LFT, are particularly suitable semi-finished products. The temperature required for molding must be below a temperature that might cause damage to the film 5. After the reinforced-reinforced plastics material has hardened or cooled, the press 7, as shown in FIG. 6, is opened and the finished structural part 10 may be removed after it has been lifted from the male mould 8, by means or ejectors 11, for example. After the edges of flashes of the glass reinforced-reinforced plastics material have, if necessary, been cleaned, the structural part may be used. The film 5 provides the structural part 10 with a surface that is ready for use and does not require any finishing or coating. A subsequent coating procedure, with reduced effort, is possible for effect colors.

1-11. (canceled)

12. A method for refining surfaces of structural parts made of reinforced-reinforced plastics materials that may be deformed by means of extrusion or thermal molding, comprising: placing a plastics material film on a mold which displays the topography of the surface of the structural part; wherein the film may already display the final desired properties with regard to the structure and optionally the color of the surface; in accordance with the topography of the surface of the structural part, inserting the preformed film into a corresponding mold; placing a fiber mat that is already saturated or is to be saturated or a polymer melt into the mold, facing the side of the film that is not the surface; wherein the molding takes place or the mat is impregnated, under vacuum, with resin and hardener and the mold is filled; and, after hardening or cooling of the reinforced-reinforced plastics material, removing the finished structural part, comprising the film and the reinforced-reinforced plastics material connected thereto, is removed from the mold.

13. The method according to claim 12, comprising placing the preformed film n one of the molding tools of a press, into the female mold or onto the male mold, placing the reinforced-reinforced plastics material comprising a thermoset or thermoplastic matrix, on the counterpart of the tool of the press, and connecting in a pressing process that is adapted to the composition of this semi-finished product, the preformed film to the mat or the polymer melt.

14. The method according to claim 13, wherein said materials and semi-finished products are reinforced-reinforced plastics materials that were produced using the long-reinforced-reinforced thermoplastic (LFT) process, the glass-mat-reinforced thermoplastic (GMT) process or the sheet-compound-compound (SMC) process.

15. The method according to claim 12, wherein the preformed film is inserted into a mold, a fiber mat is placed under the cavity of the film, the mold is closed and filled with a mixture of resin and hardener, and the mold remains closed until the injected resin has hardened.

16. The method according to claim 12, wherein the surface of the structural part is refined with a plastics material film comprising a coating layer.

17. The method according to claim 12, wherein the surface of the structural part is refined with a two-coat or three-coat coextruded film comprising a colored layer.

18. The method according to claim 12, comprising coating the film-refined surface of the structural part with an effect color.

19. The structural part made of reinforced-reinforced plastics materials, produced by the method according to claim 12, wherein a plastics material film that is preformed in accordance with the topography of the surface of the structural part and that may already display the final desired properties with regard to the structure and optionally the color of the surface, connected to a reinforced-reinforced plastics material, preferably having a thermoset or thermoplastic matrix, comprising a saturated mat or a polymer melt.

20. The structural part according to claim 16, wherein the plastics material film comprises a coating layer for refining the surface of the structural part.

21. The structural part produced according to claim 17.

22. The structural part produced according to claim 18.
